(19) United States
(12) Patent Application Publication
(10) Pub. No.: US 2014/0282034 A1
(43) Pub. Date: Sep. 18, 2014

(54) DATA ANALYSIS IN A NETWORK

(71) Applicant: HEWLETT-PACKARD DEVELOPMENT COMPANY, L.P., Houston, TX (US)

(72) Inventors: Burcu Aydin, Mountain View, CA (US); James Marron, Durham, NC (US)

(73) Assignee: Hewlett-Packard Development Company, L.P., Houston, TX (US)

(21) Appl. No.: 13/842,821

(22) Filed: Mar. 15, 2013

(51) Int. Cl. H04L 12/24

(52) U.S. Cl. CPC H04L 41/22
USPC 715/738

(57) ABSTRACT

An example method for analyzing data in a collaborative network in accordance with the present disclosure is receiving a plurality of data, constructing a dependency structure between the plurality of data by running an Expanding Window Gaussian Graphical Model on the plurality of data, decomposing the dependency structure, and providing a visualization of the decomposition of the dependency structure.

### BACKGROUND

In collaborative inventory management relationships, buyers and suppliers communicate with each other through forecasts and responses. Forecasts reflect what the buyer plans to purchase in the future, and responses reflect what the supplier expects to supply in the future. Forecasts and responses may reflect a number of items or may be generated on an item-by-item basis.

Forecasts and responses may be generated using a rolling horizon method, where forecasts and responses are updated for a number of periods during a set period of time. For example, a horizon may be eight weeks, and a period may be one week. Accordingly, a forecast and response may be generated weekly for eight weeks. A large amount of forecast and response data is created since a forecast is generated for a period in time, for example the present, in each of the eight previous weeks. This large amount of data is compounded when considering that the horizon may be much greater than eight weeks or that the period may be less than one week.

### BRIEF DESCRIPTION OF THE DRAWINGS

Example implementations are described in the following detailed description and in reference to the drawings, in which:

FIG. 1 illustrates a block diagram of an example collaborative inventory management forecast and response analysis system in accordance with an implementation;

FIG. 2 illustrates an example collaborative forecasting network of an example system in accordance with an implementation;

FIG. 3 illustrates an example collaborative forecasting network using a visualization technique in an example system in accordance with an implementation;

FIGS. 4A and 4B are examples of collaborative forecasting networks in accordance with implementations; and

FIG. 5 illustrates an example process flow diagram in accordance with an implementation.

### DETAILED DESCRIPTION

Various implementations described herein are directed to data analysis in a collaborative forecasting network. More specifically, and as described in greater detail below, various aspects of the present disclosure are directed to a manner by which the exchange of information between buyers and suppliers may be analyzed and visualized in a collaborative forecasting network. This approach allows the forecasters and respondents to plan their operations based on the needs and limitations of their supply chain partner, resulting in lower stock out rates and production costs.

Aspects of the present disclosure described herein analyze information by applying Expanding Window Gaussian Graphical Model, obtaining decomposition and providing visualization of various aspects of the information. Among other things, this approach may improve the accuracy of future forecasts, troubleshoot any inconsistencies that arise between buyer and supplier and determine meaningful information that may identify areas in which the collaborative inventory management relationship may be improved.

In one example in accordance with the present disclosure, a method for analyzing data in a collaborative network is provided. The method comprises receiving a plurality of data, standardizing the plurality of data, constructing a dependency structure between the plurality of data by running an Expanding Window Gaussian Graphical Model on the plurality of data, decomposing the dependency structure, and providing, to a display device, a visualization of the decomposition of the dependency structure.

In another example in accordance with the present disclosure, a system for analyzing data in a collaborative network is provided. The system comprises a communication interface, a data module, an Expanding Window Gaussian Graphical Model module, a decomposition module, and a visualization module. The data module is to receive a plurality of data via the communication interface. The Expanding Window Gaussian Graphical Model module is to construct a dependency structure between the plurality of data. The decomposition module is to decompose the dependency structure. The visualization module is to visualize the decomposition of the dependency structure.

In a further example in accordance with the present disclosure, a non-transitory computer-readable medium is provided. The non-transitory computer-readable medium comprises instructions that when executed cause a device to (i) receive a plurality of data, (ii) construct a dependency structure between the plurality of data by running an Expanding Window Gaussian Graphical Model on the plurality of data, (iii) decompose the dependency structure, and (iv) visualize the decomposition of the dependency structure.

FIG. 1 illustrates an example system 100 in accordance with an implementation. The system 100 comprises a data module 110, an Expanding Window Gaussian Graphical Model (EW GGM) module 120, a decomposition module 130, and a visualization module, each of which is described in greater detail below. It should be readily apparent that the system 100 depicted in FIG. 1 represents a generalized illustration and that other components may be added or existing components may be removed, modified, or rearranged without departing from a scope of the present disclosure. For example, while the system 100 illustrated in FIG. 1 includes only one data module 110, the system may actually comprise a plurality of data modules, and only one has been shown and described for simplicity.

The data module 110 may be any type of data capturing device and may receive data from a forecaster 150 and a respondent 160. In one implementation, a forecaster 150 and a respondent 160 may be supply chain partners. For example, the forecaster 150 may be a buyer, and the respondent 160 may be a supplier. The supply chain partners may engage in information sharing to achieve better production planning and hence lower production costs for the supplier, and reduced stock-out costs and other risks for the buyer. The exchange of information between the forecaster 150 and the respondent 160 may include forecasts issued by the forecaster 150 on the amount of supply the forecaster 150 may need. The exchange of information may further include responses issued by the respondent 160 related to the amount of supply the respondent 160 commits to provide. The exchange of such information may allow the respondent 160 to form more clear expectations of the upcoming demand and plan the production schedules accordingly, resulting in a more precise supply flow. For the forecaster 150, sharing of purchase plans in advance and providing regular updates results in reduced stock-out probability and inventory costs. For the respondent 160, signaling the upcoming production capacity limitations may allow a smoother and more productive manufacturing process.

In one implementation, the forecaster 150 and the respondent 160 may include, but not limited to, a single person or group of people or an automated system capable of outputting data. In another implementation, the forecast and response may include data in various formats, including, but not limited to, digital images in a format of JPEG, GIF, PNG, etc., audio content in a format of MP3, WAV, WMA, etc., video content in a format of MPEGx, H.264, AVS, AVI, etc. The content may be one type or a mix of a plurality of types.

In one implementation, a shipment from the respondent 160 to the forecaster 150 may occur at every period, the period representing a time interval that data points may be aggregated over. Forecasts and responses may be viewed as a number of input series, with each input series including, for example, a forecast value for a number of periods generated from a fixed amount of time relative to each period. At each period, the forecasts from the forecaster 150 regarding the upcoming N periods may be issued instead of only the immediate upcoming period. The updates of the forecasts may result in a structure called rolling horizon, and N periods may be identified as the horizon length of the forecasts. Accordingly, at any period, the forecaster 150 may issue forecasts for the upcoming N periods, N−1 of these periods being updates on the previous forecasts. Therefore, at each time point t, the buyer produces N forecast numbers: {F_{t,t+1},F_{t,t+2}, . . . , F_{t,t+N}}. It should be noted that the first (N−1) numbers in the forecast series of each period may be considered as updates on the existing predictions made in previous periods, while the last forecast, F_{t,t+N}, is the first forecast being issued regarding the period t+N.

In an implementation where the time interval to be analyzed may be from period t to t+T, the forecasts made for these periods, one period ago, may be denoted as the vector F1:

$${F}_{1} = [ \begin{matrix}{f}_{t - 1 , t} \\ ⋮ \\ {f}_{t + T - 1 , t + T}\end{matrix} ]$$

The forecast updates may take into account the information obtained from the forecasts issued in previous periods, as well as containing any new information that became available to the forecaster 150 in that period. Further, the difference between the time a forecast is made in and the time forecast is made for may be called the lag of that forecast number.

In addition or alternatively, the forecasting horizon of the forecast data generated by the forecaster 150 in the time interval [t,T+t] may be given as N, and thus there may be N vectors of F to analyze, each vector providing the forecasts made for the time interval [t, t+T], made 1 . . . N periods ago. The matrix including these vectors may be denoted as F:

$$F = [ \begin{matrix}{F}_{1} & … & {F}_{N}\end{matrix} ] = [ \begin{matrix}{F}_{t - 1 , t} & … & {F}_{t - N , t} \\ ⋮ & ⋱ & ⋮ \\ {F}_{t + T - 1 , t + T} & … & {F}_{t + T - N , t + T}\end{matrix} ]$$

In the above presented matrix, each row i may represent the forecasts made for the time period i. Each forecast in this row may be an update on the next forecast on this row. Each column j of the matrix may represent all the forecasts that may be issued j periods before the period they are predicting. The column Fⱼ may be the set of all the forecasts with lag j.

In another implementation, at each period, the created forecasts may be shared with the respondent 160, and in response, the respondent 160 may issue a response to the forecasts. The responses may be expressed in a similarly constructed R matrix.

$$R = [ \begin{matrix}{R}_{1} & … & {R}_{N}\end{matrix} ] = [ \begin{matrix}{R}_{t - 1 , t} & … & {R}_{t - N , t} \\ ⋮ & ⋱ & ⋮ \\ {R}_{t + T - 1 , t + T} & … & {R}_{t + T - N , t + T}\end{matrix} ]$$

In one implementation, the horizon length of responses may be different than the forecasts. In such an implementation, the response horizon may be denoted as M. These responses issued at period t may be represented with {R_{t,t+1},R_{t,t+2}, . . . , R_{t,t+M}}. In one implementation, N can be greater or equal to M (i.e., N≧M). For example, the forecasts from the forecaster 150 may have a horizon of 12 periods, resulting in 12 time series. The responses from the respondent 160 may have a horizon of 7 periods, resulting in 7 time series. For cases where N>M, in one implementation, it may be assumed that R_{N}= . . . =R_{M+1}=0 for simplicity.

In one implementation, the data module 110 may receive input data provided by the forecaster 150, which may be directly applied to the EW GGM module 120. In another implementation, the data module 110 may standardize the input data before providing the data to the EW GGM module 120.

In one implementation, the data module 110 may be employed to standardize the forecast and the response input series. Standardizing may prevent the scaling issues from dominating the results and allow the detection of correlations correctly. Standardization may correspond to linearly scaling a vector so that the mean is zero and the standard deviation is 1. In one implementation, each input vector (Fᵢ and Rᵢ) may be standardized by, for example, subtracting its mean and dividing the result by the vector's standard deviation:

$${F}_{i}^{Adjusted} = \frac{{F}_{i} - mean ( {F}_{i} )}{std ( {F}_{i} )}$$

In one implementation, the system 100 may observe Markovian property, i.e., the conditional probability distribution of future states of the process, given the present state and the past states, depends only upon the present state. In one implementation, this may correspond to the situation where the effect of the past on Fᵢ is fully captured by the events Fᵢ₊₁ and Rᵢ₊₁, and any previous event does not carry additional information. Therefore, the effect of Fᵢ₊₂ on Fᵢ may be determined to be close to zero when the effects of Rᵢ₊₂, Fᵢ₊₁ and Rᵢ₊₁ are factored out.

A monotone transformation may be applied to the data if its distribution is found to be noticeably different than normal. Monotone transformations may not distort the dependence facts. For example, if two random variables are dependent or independent, their transformed versions may be found the same.

In another implementation, the normality of the data may be tested. The normalization parameter may be identified by a Box-Cox transformation technique:

$$data ( ρ ) = \{ \begin{matrix}\frac{{data}^{ρ} - 1}{ρ} & if ρ \neq 1 \\ log ( data ) & if ρ = 1\end{matrix}$$

In one implementation, a measure of the normality of the resulting Box-Cox transformation may be defined. A normality plot for appropriate ρ's may be employed to assess normality of the input data. The value of ρ corresponding to the maximum normalization on the plot may then be the optimal choice for ρ.

In another implementation, partial correlation may be implemented to measure the degree of association between two variables with the effect of a set of controlling random variables removed. For example, the partial correlation refers to the correlation between two random variables (X and Y) when the effect of a set of external variables (Z) are removed from both of them. This may be illustrated as C(X,Y|Z), where C refers to the correlation. In an implementation where C(X,Y|Z) is very small, the correlation demonstrates that X and Y are simply reacting to a third variable (e.g., Z), and when the effect of Z is accounted for, X and Y may not be related any more.

In one implementation, a method of regression may be used for the partial correlation between X and Y, given Z, for estimating the relationships among variables. Regression analysis may be used to demonstrate how the typical value of the dependent variable changes when any one of the independent variables is varied, while the other independent variables are held fixed. For example, regression may be equivalent to factoring out Z from both X and Y, when X=Zα+ε_{X|Z} and Y=Zβ+ε_{Y|Z}. The correlation between the residuals ε_{X|Z} and ε_{Y|Z} may be the partial correlation: C(X,Y|Z)=C(ε_{X|Z},ε_{Y|Z}). In another implementation, the partial correlation may be implemented by finding the correlation matrix R of the random variable set [X,Y,Z]. For example, if R is invertible, then the entry R⁻¹(1,2) may be proportional to the partial correlation between X and Y, given Z.

The Expanding Window Gaussian Graphical Model (EW GGM) module 120 may receive the data from the data module 110. As discussed in more detail above, each variable (e.g., forecast and response) may be a combination of information that may be available from the past periods, and the new information obtained. The EW GGM module 120 may be employed to identify what portions of the interaction may be associated with what previous element or current information.

According to the method employed by the EW GGM module 120, the random variables {X₁, X₂, . . . , Xₙ} may represent events happened in a sequence indicated by their indices. These variables may form the vertices of the EW GGM network. Further, each edge may describe the conditional dependence between the random variables. For a chosen model selection parameter λ, the EW GGM module 120 first determines partial correlations of the variables by using the model selection parameter λ and a GGM method, and then determining the edges in the collaborative forecasting network.

In one implementation, a classical GGM network may be represented by an undirected graph G=(V,E), where V is the set of vertices, and E is the set of edges between the vertices. According to such network, each vertex may correspond to a random variable in the network. The random variables {X₁, X₂, . . . , Xₙ} may represent events happened in a sequence indicated by their indices. The random variables may further be defined as X˜N(μ,Σ), wherein N(μ,Σ) is the multi-variant Normal distribution that these variables are assumed to be following in the collaborative forecasting network. Further, θ is the inverse of the covariance matrix (which can be denoted as Σ⁻¹), called precision matrix. Any entry θᵢⱼ of this matrix is proportional to the partial correlation between nodes i and j. Therefore, calculating θ may result in finding the Partial Correlation matrix (PM) for the network G. The GGM method aims to calculate a sparse θ matrix. Sparsity in this matrix may be obtained by pushing the small entries of this matrix to zero.

To address the GGM, which is included in the EW GGM as a sub-routine, the EW GGM module 120 may employ the Graphical Lasso method:

Maximize log|θ|−tr(Sθ)−λ∥θ∥₁

wherein log|θ|−tr(Sθ) is the log likelihood of θ, and λ∥θ∥₁. Other methods that find a sparse precision matrix of the network may also be used.

Unlike a classical GGM, the EW GGM module 120 may accommodate the time dimension of the data in the collaborative forecasting network between the forecaster 150 and the respondent 160. An expanding time window may consist of the index set {1, . . . , i}. An edge {j,i} where j<i in the EW GGM network may exist if and only if this edge exists in the GGM with the vertex set {Xₖ|kεEWᵢ}.

In one implementation, where the set of events is a series of Vₙ={v₁, v₂, . . . , vₙ}, the time dimension of the EW GGM requires:

PC′ᵢⱼ=C(vᵢ,vⱼ|vₖεVₙ, k≠i,j and k<max(i,j))

wherein the PC′ is the matrix of relevant partial correlations in a network of nodes with a time sequence.

The EW GGM module 120 outputs:

$$\begin{matrix}{PC}_{ij}^{′} = C ( {v}_{i} , {v}_{j} \vert {v}_{k} ∈ {V}_{n} , k \neq i , j and k < max ( i , j ) ) \\ = C ( {v}_{i} , {v}_{j} \vert {v}_{k} ∈ {V}_{m} , k \neq i , j , and m = max ( i , j ) ) \\ = {PC}_{ij}^{m} , m = max ( i , j )\end{matrix}$$

wherein Vₘ={v₁, v₂, . . . , vₘ}, m≦n and PC^{m}=Partial correlation matrix of event set Vₘ.

A description of the EW GGM algorithm may be as follows:

For a chosen λ:

```
For all i from 1 to n, iterate:
      For all j from 1 to i, iterate:
            PCᵢⱼ(λ)= PCᵢⱼ^{m}(λ), m=max(i,j)
      End;
End;
```

Repeat for different λ's as necessary or as chosen by a user.

In another implementation, as discussed above as a part of the process performed by the EW GGM module 120, a model selection parameter λ may be identified. The parameter λ may control the tightness of the model selection. For example, a higher parameter λ may result in a network where as many edges may be pushed to zero as possible, and only the edges with strongest evidence of conditional dependence may remain. In another implementation, as the parameter λ is lowered, the model selection may be more relaxed, and many links with less certain conditional dependences may appear. In other implementations, an appropriate parameter λ may be provided by a user (e.g., the forecaster 150, the respondent 160 or any other party viewing the results of the analysis performed by the system 100 or involved in the collaborative forecasting network). The parameter λ may be an interactive input, where the user of the collaborative forecasting network may see the networks that result in different parameter λs by interactively changing it.

In one implementation, the model selection parameter λ may define the strength of model selection. In another implementation, the model selection parameter λ may be larger, and this may indicate a sparser model. Accordingly, the model may include only the edges with a very strong evidence of dependence. In another implementation, the model selection parameter may be smaller, and this may indicate a denser model.

The output of EW GGM module 120 may aide the decomposition model employed by the decomposition module 130. More specifically, as discussed above, the output of EW GGM module 120 determines the edges that exist in the collaborative forecasting network, and these edges identify which coefficients in the decomposition method are to be set to zero and the coefficients are to be non-zero.

The decomposition may be expressed as:

Fᵢ=αᵢ^{F}*R_{i+1:N}+βᵢ^{F}*F_{i+1:N}+εᵢ^{F}

wherein Fᵢ is the new period's prediction, αᵢ^{F}*R_{i+1:N} is information propagated from past periods' responses, βᵢ^{F}*F_{i+1:N} is information propagated from past periods' forecasts, and εᵢ^{F} is new information and noise. In one implementation, the coefficient vectors α's and β's may contain many zero entries. For example, the α and β are set to zero if no edge is found from their corresponding event to Fᵢ. In another implementation, the non-zero entries may indicate which past events influenced the Fᵢ, and the magnitude of these non-zero entries may be proportional to the magnitude of the corresponding influence.

In one implementation, the decomposition module 130 may use linear regression to obtain the influence magnitudes of each element. For example, the EW GGM module 120 may reveal that forecasts with lag 2 (F₂) are influenced by past events F₃, F₄ and R₃. Based on this information, the decomposition module 130 may illustrate:

F₂=[F₃F₄R₃]*α+ε₂^{F}

The vector α may be calculated using regression or any other appropriate method.

In one implementation, the vector α may be [0.1; 0.2; 0.5]. Accordingly, in such implementation, the random variable F₂ may be expressed as the sum of four random variables: 0.1*F₃, 0.2*F₄, 0.5*R₃ and εF₂. These random variables may have standard deviations 0.1, 0.2, 0.5 and 0.2. Accordingly, the decomposition module 130 determines that the 10 percent of the variability in F₂ may be from past event F₃, 20 percent from F₄, 50 percent from R₃ and 20 percent new information.

The visualization module 140 may illustrate the decomposition of the data flow in the collaborative forecasting network. The visualization module 140 may arrange nodes around an elliptical structure to minimize the clutter, considering the number of arrows drawn over each other. In one implementation, the forecasts may be arranged on the top hemisphere of the ellipse and responses may be on the lower hemisphere to enable quick visual inspection of forecast-response interaction.

A display device 170 may be connected to the system 100 and may display the plurality of forecast and response series. The forecaster 150 and the respondent 160 may view the illustrations provided by the visualization module 140 on the display device 170. As also described above in greater detail with reference to FIG. 1, the display device 170 may be a screen, monitor, television, panel, board, curtain, wall or any other surface.

In one implementation, a storage device 180 may be connected to the system 100 and may store a number of forecast and response input series. Alternatively or in addition, the storage device 180 may store standardized versions of the forecast and response input series.

The system 100 may be implemented in a user device (e.g., a laptop, desktop, tablet, smart phone, medical instrument, scientific instrument, etc.). The system 100 may include a processor and memory and help translate input data received from the forecaster 150 and/or the respondent 160 into appropriate feedback for the display device 170. The processor and the computer readable medium may be connected via a bus. The computer readable medium may comprise various databases containing, for example, a forecast database, a response database, a standardized forecast database and a standardized response database.

The processor may retrieve and execute instructions stored in the computer readable medium. The processor may be, for example, a central processing unit (CPU), a semiconductor-based microprocessor, an application specific integrated circuit (ASIC), a field-programmable gate array (FPGA) configured to retrieve and execute instructions, other electronic circuitry suitable for the retrieval and execution instructions stored on a computer readable storage medium, or a combination thereof. The processor may fetch, decode, and execute instructions stored on the storage medium to operate the system 100 in accordance with the above-described examples. The computer readable medium may be a non-transitory computer-readable medium that stores machine readable instructions, codes, data, and/or other information.

In certain implementations, the computer readable medium may be integrated with the processor, while in other implementations, the computer readable medium and the processor may be discrete units.

Further, the computer readable medium may participate in providing instructions to the processor for execution. The computer readable medium may be one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices.

In one implementation, the computer readable medium may have a forecast database, a response database, a standardized forecast database and a standardized response database. The forecast database may store forecast data such as product description, quantity, purchase schedule, forecaster data and/or the like. The response database may store product description, quantity, schedule, respondent data and/or the like. To create a high level of security, packet filter access can be installed between databases. Consistent with the present disclosure, the databases could be maintained as a single database.

The processor may comprise at least one high-speed data processor adequate to execute program components for executing user and/or system-generated requests. In one implementation, the processor may include a software module that processes the data including forecasts and responses captured by the data module 110 from the forecaster 150 and the respondent 160. This module may also be used to standardize the forecasts and responses. Moreover, the processor may include a software module that runs an EW GGM on the forecasts and responses to construct the dependence structure between various forecasts and responses. Alternatively or in addition, the processor may provide a way to decompose the dependence structure to identify the influence magnitudes of the forecasts and responses and visualize the dependence structure.

In one implementation, each module 110, 120, 130 and 140 may share a common processor and memory. In another implementation, each module may have a separate processor and/or memory. Additionally, the programming that enables the functionality of each module 110, 120, 130 and 140 may be included in the same executable file or library.

In some implementations, the forecaster 150 and/or the respondent 160 may interact with the system 100 by controlling an input device (e.g., keyboard, mouse, etc.) through a user interface attached to the system 100 and/or the display device 170. The user interface may be a display of a computer. In one example system, such display may present various pages that represent applications available to the forecaster 150 and the respondent 160. The user interface may facilitate interactions of the forecaster 150 or the respondent 160 with the system 100 by inviting and responding to input from the forecaster 150 or the respondent 160 and translating tasks and results to a language or image that the system 100 can understand. In another implementation, the display device 170 may be a touch sensitive display device and act as a user interface for the forecaster 150 and the respondent 160.

FIG. 2 illustrates an example collaborative forecasting network 200 (i.e., a forecast-response network) in accordance with an implementation. The collaborative forecasting network 200 comprises a plurality of forecasts (forecasts 210 and 220), a plurality of responses (responses 230 and 240), and sale 250, which represents the final purchase. The collaborative forecasting network 200 may demonstrate the events that occur until a purchase is realized. The arrows may show how events (i.e., forecasts and responses) affect other events. For example, the response 240 may happen right after the forecast 220, and it may depend on the forecast 220 and the response 230. It may affect the sale 250, which is the actual shipment vector S, expressing the realized purchases. It should be readily apparent that the collaborative forecasting network 200 depicted in FIG. 2 represents a generalized illustration and that other components may be added or existing components may be removed, modified, or rearranged without departing from a scope of the present disclosure. For example, while the collaborative forecasting network 200 illustrated in FIG. 2 includes only two forecasts (i.e., the forecasts 210 and 220), the collaborative forecasting network may actually comprise a plurality of forecasts, and only two have been shown and described for simplicity.

In one implementation, the collaborative forecasting network comprises a plurality of edges. The edges that feed into a node may represent the past events that influenced the event associated with the node. The edges that go out of the node may define the future events the node is influenced by. Accordingly, the forecast 210 may be the first information regarding the upcoming purchase (i.e., the sale 250). The forecast 220 may consist of the forecaster 150's forecast on the amount of product that may be purchased in 2 periods. The response 230 may be the respondent 160's response to the forecast 210, and may include data related to the amount of product the respondent 160 may provide in 2 periods. The response 230 may depend on the amount of product the forecaster 150 requests (the forecast 210) and the knowledge of the respondent 160 of his production plans. The next event, the forecast 220 may be the forecaster 150's updated forecast in the next period. The forecast 220 may contain the information that the forecaster 150 already had from the last period (the forecast 210), the availability signal from the respondent 160 (the response 230), and any new information that may be obtained in this period. The response 240 may be the new response from the respondent 160, containing the most up-to-date information provided by the forecast 220, availability information that may be carried over from the past (the response 230), and any new information that became available to the respondent 160 in this period. The final realization, the sale 250, may be a function of the most recent data, including the forecast 220 and the response 240.

As discussed above in more detail with respect to FIG. 1, each event in the collaborative forecasting network 200 may contain the information represented by the most recent updates, and any new information that the forecaster 150 acquires. It should be noted that no line may be shown between the forecast 210 and the response 240. As discussed above in more detail with respect to FIG. 1, the information in the forecast 210 may be carried over to the response 240 through the forecast 220 and the response 230. Accordingly, in one implementation, F_{N-1} (the forecast 220) may carry information from F_{N} (i.e., the forecast 210), R_{N} (i.e., the response 230), and new information that may become available in period N−1, and noise. The new information may be contained in the epsilon (ε).

It should be noted that one of the aspects of the present disclosure herein is directed to verifying that the collaborative forecasting network functions as described above.

For lag N,

F_{N}=ε_{N}^{F}

R_{N}=β_{N}^{R}*F_{N}+ε_{N}^{F}

For any time period, the first prediction introduced for this period (lag N) may be in the vector F_{N}. F_{N} may carry the forecaster 150's initial estimate for the amount of product the forecaster 150 may purchase. In addition or alternatively, F_{N} may carry external and internal information. R_{N}, on the other hand, may include information from F_{N}, outside factors, and noise.

For lag i=1 . . . (N−1),

Fᵢ=αᵢ^{F}*R_{i+1:N}+βᵢ^{F}*F_{i+1:N}+εᵢ^{F}

Rᵢ=αᵢ^{R}*R_{i+1:N}+βᵢ^{R}*F_{i:N}+εᵢ^{R}

where F_{i:N}=[_{Fi}, . . . , F_{N}]. Fᵢ stands for the new period's prediction. αᵢ^{F}*R_{i+1:N} represents the information propagated from the past periods' responses. βᵢ^{F}*F_{i+1:N} represents the information propagated from the past periods' forecasts. εᵢ^{F} represents the new information and noise. Rᵢ represents the new period's response. αᵢ^{R}*R_{i+1:N} represents the information propagated from the past periods' responses. βᵢ^{R}*F_{i:N} represents the information from propagated from the new period's forecast. εᵢ^{R} represents the new information and noise.

For S (i.e., the sale 250),

S=α^{S}*R+β^{S}*F+ε^{S}

FIG. 3 illustrates a collaborative forecasting network using a visualization technique 300 in accordance with one implementation. The visualization technique 300 represents the decomposition of the information flow in the collaborative forecasting network. The collaborative forecasting network has a model selection parameter of 0.8. It should be understood that the visualization 300 in FIG. 3 represents a generalized illustration and that other components may be added or existing components may be removed, modified, or rearranged without departing from a scope of the present disclosure. For example, while the collaborative forecasting network includes eight forecasts (F1 . . . F8), more or less number of forecasts may be included, and eight have been shown as an example.

In the implementation illustrated in FIG. 3, the visualization technique 300 illustrates each of the forecast (F1 . . . F8) and the response (R1 . . . R7) as a node. The visualization technique 300 arranges nodes around an elliptical structure to minimize the clutter, considering the number of arrows drawn over each other. In one implementation, the horizontal line 310 represents the timeline. The X coordinate of the position of each node indicates the time point that the event happened on the timeline. The vertical lines 320 from the nodes are used to identify when the corresponding events happen. It should be noted that all the vertical lines are used to identify when each corresponding event happened and may be marked as 320. For simplicity, only two of the vertical lines are marked as 320. Moreover, the Y coordinates of the nodes are determined such that the nodes are arranged on an ellipse. As discussed above, this approach may allow viewing the edges with least amount of overlap. In some implementations, the forecasts may be arranged on the top hemisphere of the ellipse and responses may be on the lower hemisphere to enable quick visual inspection of forecast-response interaction. In another implementation, the shipment node (not shown in FIG. 3) may sit on the rightmost end of the timeline. It should be noted that the visualization in FIG. 3 depicts only an example, and various parts of the visualization may look different when applied to different forecasts and responses.

In one implementation, the visualization technique 300 may illustrate that the only influence between the forecasts (F1 . . . F8) and the responses (R1 . . . R7) may appear from F5 to the responses R5 and R4. In some implementations, this may signal a production delay of 4 periods. For example, a respondent (e.g., supplier) may need 4 weeks to manufacture the product being purchased by a forecaster (e.g., buyer). Accordingly, the respondent, when determining the amount of production 4 periods ahead, may use F5 as the most recent forecast from the forecaster. The respondent may not react to earlier forecasts because the earlier forecasts may not be considered recent at the time of the production decision. Accordingly, F6, F7 and F8 may not have any influence on the collaborative forecasting network. In addition or alternatively, the lack of influence from the later forecasts may be due to timing since at the time they may be made, the respondent may have determined the amount of product to be supplied and is already in the production phase. It should be noted that the insights identified for the implementation illustrated in FIG. 3 are examples only, and different or additional insights may be developed for different forecasts and responses.

In one implementation, the visualization technique 300 may demonstrate that the forecasts may be closely linked to each other, and the responses are closely linked to each other. In another implementation, the influence between the forecasts and the responses may be limited. In a further implementation, some of the responses or forecasts may be removed. For example, R1 may be a response from the respondent right before the realization of the purchase. Accordingly, R1 may not be linked to any other events as it may not influence any forecasts since the forecaster does not have any additional forecasts at that point that R1 may have an influence on. Therefore, R1 may be removed.

FIGS. 4A and 4B illustrate example collaborative forecasting networks using the visualization technique 300 discussed in FIG. 3 in accordance with one implementation. Similar to FIG. 3, FIGS. 4A and 4B represent generalized illustrations, and that other forecasts may be added or existing forecasts may be removed, modified, or rearranged without departing from the scope and spirit of the present disclosure.

As discussed above with respect to FIG. 3, the collaborative forecasting network illustrated in FIG. 3 has a model selection parameter of 0.8. FIGS. 4A and 4B provide collaborative forecasting networks obtained by changing the model selection parameter to 0.7 and 0.9. Other implementations may include collaborative forecasting networks with other model selection parameters. In one implementation, a range from [0.7 to 1] may be used. In such implementation, an exploration of network visualizations with different model selection parameters allows an observer to see how the tightness of the model selection may change based on the model selection parameter. For example, as discussed above in more detail with reference to FIG. 1, a higher parameter may result in a network where as many edges may be pushed to zero as possible, and only the edges with strongest evidence of conditional dependence may remain. As the parameter is lowered, the model selection may be more relaxed, and many links with less certain conditional dependences may appear. FIG. 4A illustrates that the model selection parameter of 0.7 may provide too little model selection. FIG. 4B illustrates that the parameter of 0.9 may be too tight, erasing most of the links.

When the visualization of the collaborative forecasting network in FIG. 3 is compared to the visualizations of the collaborative forecasting networks in FIGS. 4A and 4B, the model selection parameter of 0.8 seems to be the most reasonable value.

In one implementation, this parameter may also be an interactive input, where a user may see the networks that result in different parameter λs by interactively changing it.

Turning now to the operation of the system 100, FIG. 5 illustrates an example process flow diagram 500 in accordance with an implementation. More specifically, FIG. 5 illustrates processes that may be conducted by the system 100 in accordance with an implementation. It should be readily apparent that the processes illustrated in FIG. 5 represents generalized illustrations, and that other processes may be added or existing processes may be removed, modified, or rearranged without departing from the scope and spirit of the present disclosure. Further, it should be understood that the processes may represent executable instructions stored on memory that may cause a processor to respond, to perform actions, to change states, and/or to make decisions. Thus, the described processes may be implemented as executable instructions and/or operations provided by a memory associated with a system 100. Alternatively or in addition, the processes may represent functions and/or actions performed by functionally equivalent circuits like an analog circuit, a digital signal processor circuit, an application specific integrated circuit (ASIC), or other logic devices associated with the system 100. Furthermore, FIG. 5 is not intended to limit the implementation of the described implementations, but rather the figure illustrates functional information one skilled in the art could use to design/fabricate circuits, generate software, or use a combination of hardware and software to perform the illustrated processes.

The process 500 may begin at block 505, where a set of data is received related to a forecaster and a respondent. As discussed above in more detail with reference to FIG. 1, a forecaster may be a buyer of a product, and the data may include the buyer's forecast related the amount of product the buyer anticipates to purchase. Further, the respondent may be a supplier or a seller of the product, and the data may include the supplier's response related to the amount of product he plans to provide. As further discussed above, the forecaster and the respondent may provide a plurality of forecasts and responses during a time interval. A forecast is a combination of information that is available from the past periods (e.g., past response and past forecast), and any new information obtained. Moreover, a response is a combination of information that is available from the past periods (e.g., past response and latest forecast) and any new information obtained.

At block 510, the received data is standardized. In particular, this process may involve to linearly scaling the data so that the mean of the data set is zero and its standard deviation is 1. In addition or alternatively, this process may involve testing for the normality of input data, and apply a monotone transformation to the data if its distribution is noticeably different than normal.

At block 515, an Expanding Window Gaussian Graphical Model (EW GGM) is applied to the standardized data to construct a dependence structure between the forecasts and responses. In particular, this process may involve identifying past events (i.e., forecasts and responses) that influenced the current event (i.e. a forecast or a response). In particular, this process may also involve calculating a selection model parameter λ needed to control the tightness of the model.

At block 520, after constructing the dependence structure, the structure is decomposed to obtain the magnitudes of dependence between the observed events. In particular, this process may involve determining what portions of the data flow come from what previous element or current information. For example, the process may involve analyzing a current forecast and identifying the magnitude of influence a past forecast has on the current forecast. In addition, the process may further involve identifying the magnitude of influence a past response has on the current forecast. In addition, the process may involve identifying the magnitude of influence any new information that may have become available and/or any noise that the network may be exposed to have on the current forecast. As a part of the process for obtaining the decomposition, a linear regression method may be applied.

At block 525, a visualization technique is used to illustrate the decomposition of the information flow network. As discussed above in more detail with reference to FIG. 3, the decomposition of the network may be arranged on an ellipse using nodes and edges. Nodes may be used to identify various events including forecasts and responses, and edges from one node to another may be drawn if the EW GGM method indicates that these events are conditionally dependent. The visualization allows a forecaster, respondent or another party interacting with the network to inspect the network and observe the information flow. Accordingly, this allows deeper insights into the process being performed in the network and enabling productive improvements to the process.

At block 530, the system determines whether the model selection parameter is appropriate for the network. As discussed above in more detail in reference to FIGS. 4A and 4B, a parameter controls the tightness of the model selection, and a higher parameter may result in a network where as many edges are pushed to zero as possible, whereas with a smaller parameter, the model selection may be more relaxed, and many links with less certain conditional dependences may appear.

If the parameter is determined to be appropriate, at block 535, the visualization is maintained. If it is determined that the parameter is not the ideal for the information flow network, at block 540, an appropriate model selection parameter is determined. In particular, this process may involve applying a range of model selection parameters to the network and based on the number of edges observed, identifying an appropriate parameter value.

The present disclosure has been shown and described with reference to the foregoing exemplary implementations. It is to be understood, however, that other forms, details, and examples may be made without departing from the spirit and scope of the disclosure that is defined in the following claims. As such, all examples are deemed to be non-limiting throughout this disclosure.

What is claimed is:

1. A method for analyzing data in a collaborative network, comprising:
receiving, through a communications device, a plurality of data;
standardizing, by a processor, the plurality of data;
constructing, by the processor, a dependency structure between the plurality of data by running an Expanding Window Gaussian Graphical Model on the plurality of data;
decomposing, by the processor, the dependency structure; and
providing, to a display device, a visualization of the decomposition of the dependency structure.

2. The method of claim 1, wherein receiving the plurality of data further comprises receiving at least one forecast from a buyer and at least one response from a supplier.

3. The method of claim 2, wherein the at least one response from the supplier depends on the at least one forecast from the buyer, new data that becomes available to the collaborative network, and noise in the collaborative network.

4. The method of claim 1, wherein receiving the plurality of data further comprises receiving the plurality of data periodically in a collaborative forecasting network.

5. The method of claim 1, wherein the Expanding Window Gaussian Graphical Model identifies conditional dependency links between the plurality of data only on conditions related to past data, excluding future data.

6. The method of claim 1, wherein the Expanding Window Gaussian Graphical Model accommodates a time dimension of the collaborative network, the time dimension existing in the collaborative network with the plurality of data being indexed by time.

7. The method of claim 1, wherein decomposing the dependency structure further comprises obtaining magnitudes of influence between the plurality of data based on the dependency structure.

8. The method of claim 1, wherein decomposing the dependency structure further comprises running decomposition regressions.

9. The method of claim 1, wherein providing the visualization of the decomposition of the dependency structure further comprises visualizing the decomposition of the dependency structure based on a model selection parameter.

10. The method of claim 9, wherein the model selection parameter controls a tightness level associated with the visualization.

11. The method of claim 10, wherein the tightness level identifies a level of certainty required in the dependency structure to be included in the visualization.

12. The method of claim 9, wherein further comprises:
determining, based on the visualization, whether the model selection parameter is appropriate for the collaborative network;
if the model selection parameter is not appropriate, visualizing the decomposition of the dependency structure with a different model selection parameter; and
if the model selection parameter is appropriate, maintaining the visualization.

13. A system for analyzing data in a network, comprising:
a communication interface;
a data module to receive a plurality of data via the communication interface;
an Expanding Window Gaussian Graphical Model module to construct a dependency structure between the plurality of data;
a decomposition module to decompose the dependency structure; and
a visualization module to visualize the decomposition of the dependency structure.

14. The system of claim 13, wherein the data module standardizes the plurality of data.

15. The system of claim 13, further comprising a display unit to display the visualization of the decomposition of the dependency structure.

16. The system of claim 13, further comprising a storage unit to store the plurality of data.

17. The system of claim 13,
wherein the visualization module uses nodes and edges; and
wherein the nodes present the plurality of data, and the edges present the dependency structure between the plurality of data.

18. The system of claim 13,
wherein the plurality of data comprises at least one forecast and at least one response; and
wherein the visualization module arranges the at least one forecast on the top hemisphere of an ellipse, and the at least one response on the lower hemisphere of the ellipse.

19. The system of claim 18, wherein the arrangement provides a visual inspection of interaction between the at least one forecast and the at least one response.

20. A non-transitory computer-readable medium comprising instructions that when executed cause a system to:
receive a plurality of data;
construct a dependency structure between the plurality of data by running an Expanding Window Gaussian Graphical Model on the plurality of data;
decompose the dependency structure; and
visualize the decomposition of the dependency structure.
